(19) United States
(12) Patent Application Publication
(10) Pub. No.: US 2022/0374525 A1
(43) Pub. Date: Nov. 24, 2022

(54) APPARATUS AND METHOD FOR DETECTING VULNERABILITY TO NONVOLATILE MEMORY ATTACK

(71) Applicant: ELECTRONICS AND TELECOMMUNICATIONS RESEARCH INSTITUTE, Daejeon (KR)

(72) Inventors: GAE-IL AN, Daejeon (KR); Yang-Seo CHOI, Daejeon (KR)

(73) Assignee: ELECTRONICS AND TELECOMMUNICATIONS RESEARCH INSTITUTE, Daejeon (KR)

(21) Appl. No.: 17/525,604

(22) Filed: Nov. 12, 2021

(30) Foreign Application Priority Data
May 18, 2021 (KR) 10-2021-0064288

(51) Int. Cl. G06F 21/57; G06N 7/02; G06F 3/06

(52) U.S. Cl. CPC G06F 21/577; G06N 7/023; G06F 3/0622; G06F 3/0659; G06F 3/0679; G06F 2221/034

(57) ABSTRACT

Disclosed herein are an apparatus and a method for detecting a vulnerability to a nonvolatile memory attack. The apparatus for detecting a vulnerability to a nonvolatile memory attack includes memory for storing at least one program, and a processor for executing the program, wherein the program includes a fuzzer unit for sending a fuzzing message to fuzzing target software, a nonvolatile memory write control unit for, when a request to write data to a nonvolatile memory is received from the fuzzing target software, transferring nonvolatile memory write data to an attack vulnerability detection unit, and the attack vulnerability detection unit for, when the nonvolatile memory write data is received from the nonvolatile memory write control unit, searching for a vulnerability to a nonvolatile memory attack based on a result of determining whether the nonvolatile memory write data is normal based on a model pre-trained in a normal state.

### CROSS REFERENCE TO RELATED APPLICATION

This application claims the benefit of Korean Patent Application No. 10-2021-0064288, filed May 18, 2021, which is hereby incorporated by reference in its entirety into this application.

### BACKGROUND OF THE INVENTION

### 1. Technical Field

The following embodiments relate generally to technology for detecting a security vulnerability of computer software, and more particularly to a method and an apparatus that effectively detect a vulnerability to a nonvolatile memory attack in a fuzzing test environment in which testing for security vulnerabilities of industrial control system software is performed.

### 2. Description of the Related Art

A vulnerability to a nonvolatile memory attack corresponds to a Denial of Service (DoS) attack, and is mainly discovered in industrial control system devices. Because software for performing an independent industrial control function is the core part of industrial control system devices, the results of updating such software are typically reflected at the time of system booting.

Therefore, when a vulnerability to a nonvolatile memory attack is present in executable code for updating software, a cyber attacker can permanently damage the corresponding system by polluting nonvolatile memory, which stores a system boot program, using the vulnerability.

### SUMMARY OF THE INVENTION

An embodiment is intended to accurately detect a vulnerability to a nonvolatile memory attack that causes failures in system booting by polluting the nonvolatile memory of a test target system without interrupting a fuzzing test.

In accordance with an aspect, there is provided an apparatus for detecting a vulnerability to a nonvolatile memory attack, including memory for storing at least one program, and a processor for executing the program, wherein the program includes a fuzzer unit for sending a fuzzing message to fuzzing target software, a nonvolatile memory write control unit for, when a request to write data to a nonvolatile memory is received from the fuzzing target software, transferring nonvolatile memory write data to an attack vulnerability detection unit, and the attack vulnerability detection unit for, when the nonvolatile memory write data is received from the nonvolatile memory write control unit, searching for a vulnerability to a nonvolatile memory attack based on a result of determining whether the nonvolatile memory write data is normal based on a model pre-trained in a normal state.

The attack vulnerability detection unit may perform, when the nonvolatile memory write data is received, determining whether a fuzzing test is being performed depending on a notification received from the fuzzer unit as to whether the fuzzing test is to be performed, when the fuzzing test is being performed, determining whether the nonvolatile memory write data is normal based on the model pre-trained in a normal state, and when the nonvolatile memory write data is determined to be abnormal, determining that a vulnerability to a nonvolatile memory attack is present.

The attack vulnerability detection unit may further perform, when the fuzzing test is being performed, labeling the nonvolatile memory write data with test data, and determining whether the nonvolatile memory write data is normal may include determining whether the nonvolatile memory write data is normal based on output of the model that receives the nonvolatile memory write data labeled with the test data.

The attack vulnerability detection unit may further perform, when the fuzzing test is not being performed, labeling the nonvolatile memory write data with normal data, and the normal data may be used as learning data of the model.

The model may be trained such that a result indicating normality is output when the normal data is input.

The nonvolatile memory write control unit may perform, when the request to write data to the nonvolatile memory is received from the fuzzing target software, transferring the nonvolatile memory write data to the attack vulnerability detection unit, and the nonvolatile memory write control unit may further perform determining whether a fuzzing test is being performed, and controlling writing of the nonvolatile memory write data to the nonvolatile memory depending on whether the fuzzing test is being performed.

The nonvolatile memory write control unit may hook the nonvolatile memory write data using a hooking program.

The nonvolatile memory write control unit may skip writing of data requested to be written to the nonvolatile memory when the fuzzing test is being performed.

In accordance with another aspect, there is provided a method for detecting a vulnerability to a nonvolatile memory attack, including when nonvolatile memory write data is received, determining whether a fuzzing test is being performed, when the fuzzing test is being performed, determining whether the nonvolatile memory write data is normal based on a model pre-trained in a normal state, and when the nonvolatile memory write data is determined to be abnormal, determining that a vulnerability to a nonvolatile memory attack is present.

The method may further include, when the fuzzing test is being performed, labeling the nonvolatile memory write data with test data, wherein determining whether the nonvolatile memory write data is normal may include determining whether the nonvolatile memory write data is normal based on output of the model that receives the nonvolatile memory write data labeled with the test data.

The method may further include, when the fuzzing test is not being performed, labeling the nonvolatile memory write data with normal data, wherein the normal data may be used as learning data of the model.

The model may be trained such that a result indicating normality is output when the normal data is input.

In accordance with a further aspect, there is provided a method for controlling writing to a nonvolatile memory, including, when a request to write data to a nonvolatile memory is received from fuzzing target software, transferring nonvolatile memory write data to an attack vulnerability detection unit, wherein the method may further include determining whether a fuzzing test is being performed, and controlling writing of the nonvolatile memory write data to the nonvolatile memory depending on whether the fuzzing test is being performed.

Transferring the nonvolatile memory write data may include hooking the nonvolatile memory write data using a hooking program.

Controlling the writing may include skipping writing of data requested to be written to the nonvolatile memory when the fuzzing test is being performed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram of an attack on nonvolatile memory in an industrial control system;

FIG. 2 is a schematic block configuration diagram of an apparatus for detecting a vulnerability to a nonvolatile memory attack according to an embodiment;

FIG. 3 is a block diagram illustrating a nonvolatile memory write control unit according to an embodiment;

FIG. 4 is a flowchart illustrating a method for detecting a vulnerability to a nonvolatile memory attack according to an embodiment;

FIG. 5 is a flowchart illustrating the operation of a nonvolatile memory write control unit according to an embodiment;

FIG. 6 is a flowchart illustrating the operation of an attack vulnerability detection unit according to an embodiment; and

FIG. 7 is a diagram illustrating the configuration of a computer system according to an embodiment.

### DESCRIPTION OF THE PREFERRED EMBODIMENTS

Advantages and features of the present invention and methods for achieving the same will be clarified with reference to embodiments described later in detail together with the accompanying drawings. However, the present invention is capable of being implemented in various forms, and is not limited to the embodiments described later, and these embodiments are provided so that this invention will be thorough and complete and will fully convey the scope of the present invention to those skilled in the art. The present invention should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present invention.

The terms used in the present specification are merely used to describe embodiments, and are not intended to limit the present invention. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present invention pertains. Further, terms defined in generally used dictionaries are not to be interpreted as having ideal or excessively formal meanings unless they are definitely defined in the present specification.

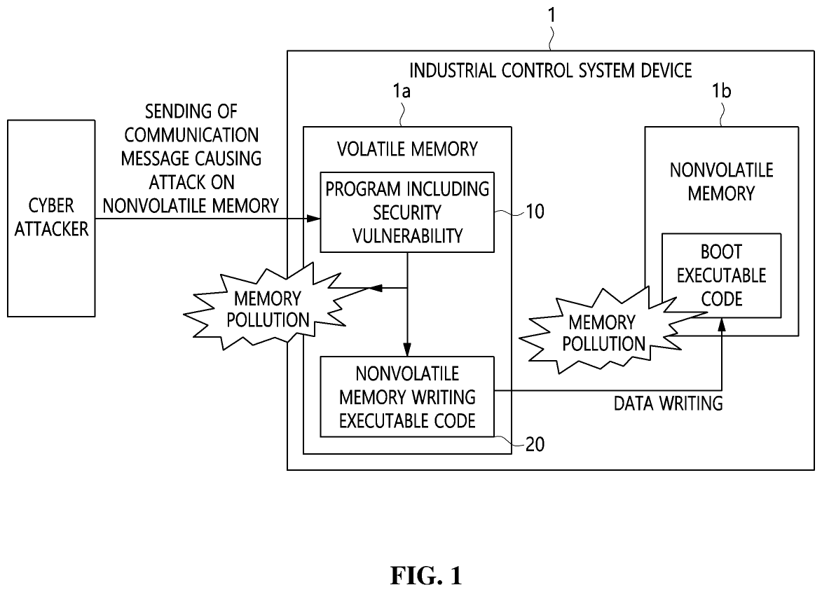

Hereinafter, an apparatus and a method according to embodiments will be described in detail with reference to FIGS. 1 to 7.

FIG. 1 is a conceptual diagram illustrating an attack on nonvolatile memory in an industrial control system.

Referring to FIG. 1, an industrial control system device 1 includes volatile memory 1a and nonvolatile memory 1b, wherein a program 10 including a security vulnerability may be executed in the volatile memory 1a.

At this time, when a cyber attacker sends a communication message causing an attack on nonvolatile memory to the program 10 including a security vulnerability, an exceptional control flow occurs in the program 10 including a security vulnerability, which is the target of attack, due to data contained in the received communication message, and thus a shared memory area may be polluted.

In this case, when the nonvolatile memory 1b (e.g., flash memory) is updated with data of the polluted memory 1a so as to update booting code, the nonvolatile memory 1b is also polluted, thus resulting in a permanent failure in which system booting is not performed.

Therefore, in order to overcome this problem, there is a need to discover in advance a security vulnerability in software, and one of the most widely used software testing methods is fuzzing technology.

Here, the term “fuzzing” refers to a kind of black-box testing technology that exploits a method of transmitting a modified input value to testing target software so as to discover fatal errors or faults in computer software.

Generally, a fuzzing system may be composed of a fuzzer, a fuzzing monitoring module, and test target software.

Here, the fuzzer functions to generate a modified input value and transmit the modified input value to the test target software. Further, when a crash, that is, a phenomenon in which software stops functioning or disappears, occurs in the test target software through fuzzing, the fuzzing monitoring module functions to collect the location where the crash occurred (e.g., the address value of memory) and status information (e.g., register information), and to re-execute the test target software (or reboot the system) so that fuzzing can continue to be performed.

Here, when fuzzing performance is evaluated, the most important elements are fuzzing automation and code coverage.

Since software having high complexity may require about tens of days to perform fuzzing, fuzzing automation, which enables fuzzing operations, such as the storage of results of performing rebooting when a crash occurs in the generation of fuzzing messages, to be automatically performed must be provided. Also, the corresponding fuzzing system may be regarded as a high-performance fuzzing system only when code coverage indicating the extent to which code is executed through a test in test target software is high in a fuzzing system so as to discover all vulnerabilities contained in the test target software.

When a fuzzing target is software including a vulnerability to a nonvolatile memory attack, additional fuzzing for discovering other vulnerabilities cannot be performed due to damage to the nonvolatile memory. That is, when software including a vulnerability to a nonvolatile memory attack is fuzzed, a problem may arise in that fuzzing automation cannot be realized, and code coverage is then decreased, thus making it impossible to actually perform fuzzing.

Also, there is an additional problem in that it is difficult to accurately detect a vulnerability to a nonvolatile memory attack. For example, once it is concluded that the cause of non-booting of a system is a vulnerability to a nonvolatile memory attack because the system does not boot once during a fuzzing test, a false-positive problem, in which an additional cause other than a vulnerability to a nonvolatile memory attack is falsely determined to be a vulnerability, may occur. Similarly, when the system boots normally even if the test target software is under an attack on nonvolatile memory, a false-negative problem in which a vulnerability to a nonvolatile memory attack cannot be detected may occur.

In the conventional technology, automation technology for solving the two problems described above has not yet been proposed, and instead, a primitive method in which a person manually and physically recovers nonvolatile memory is used. This method is performed such that, before fuzzing is performed, source data in nonvolatile memory is backed up in advance, and such that, when the system does not boot during fuzzing, the nonvolatile memory is physically detached from the system, after which the backed-up source data is copied to the nonvolatile memory through an external copy device. Such a method is a manual task which takes a considerably long time.

Therefore, in order to solve the conventional problems, the embodiment is intended to provide an apparatus and a method that accurately detect a vulnerability to a nonvolatile memory attack that causes failures in system booting by polluting the nonvolatile memory of a test target system, without interrupting a fuzzing test.

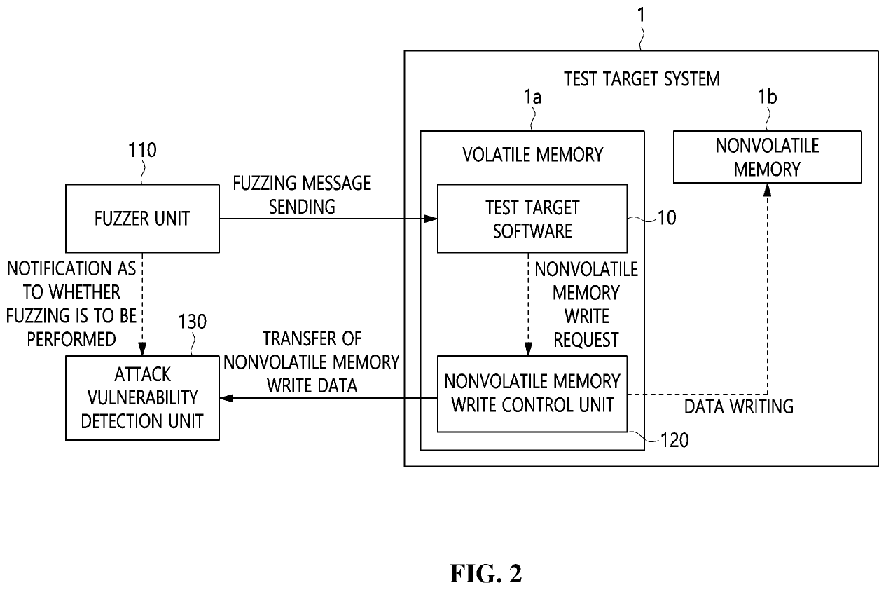

FIG. 2 is a schematic block configuration diagram of an apparatus for detecting a vulnerability to a nonvolatile memory attack according to an embodiment.

Referring to FIG. 2, the apparatus for detecting a vulnerability to a nonvolatile memory attack according to the embodiment may include a fuzzer unit 110, a nonvolatile memory write control unit 120, and an attack vulnerability detection unit 130.

The fuzzer unit 110 transmits a notification as to whether fuzzing is to be performed to the nonvolatile memory write control unit 120 and to the attack vulnerability detection unit 130 while sending a fuzzing message to test target software (or fuzzing target software) 10.

Here, the fuzzing message may be a message generated to cause a crash with the test target software 10.

When a request to write data to nonvolatile memory is received from the test target software 10, the nonvolatile memory write control unit 120 may transfer data to be written to the nonvolatile memory to the attack vulnerability detection unit 130.

Further, the nonvolatile memory write control unit 120 may control the test target software 10 residing in volatile memory 1a so that the test target software 10 writes data to the nonvolatile memory 1b.

That is, in accordance with an embodiment, the nonvolatile memory write control unit 120 allows the test target software 10 to access the nonvolatile memory 1b and to write data to the nonvolatile memory 1b when a fuzzing test is not being performed, but does not allow the test target software 10 to write data to the nonvolatile memory 1b while a fuzzing test is being performed.

When the data to be written to the nonvolatile memory is received from the nonvolatile memory write control unit 120, the attack vulnerability detection unit 130 searches for a vulnerability to a nonvolatile memory attack based on the results of determining whether the data to be written to the nonvolatile memory (i.e., nonvolatile memory write data) is normal based on a model pre-trained in a normal state.

For this operation, the attack vulnerability detection unit 130 generates a model by learning previously received data to be written to the nonvolatile memory.

That is, the attack vulnerability detection unit 130 learns nonvolatile memory write data that is received while a fuzzing test is not being performed as normal data, generates the model for determining whether nonvolatile memory data is normal, and determines whether nonvolatile memory write data that is received while the fuzzing test is being performed is normal or abnormal by applying the model for determining whether nonvolatile memory data is normal to the received nonvolatile memory write data, thus detecting a vulnerability to a nonvolatile memory attack.

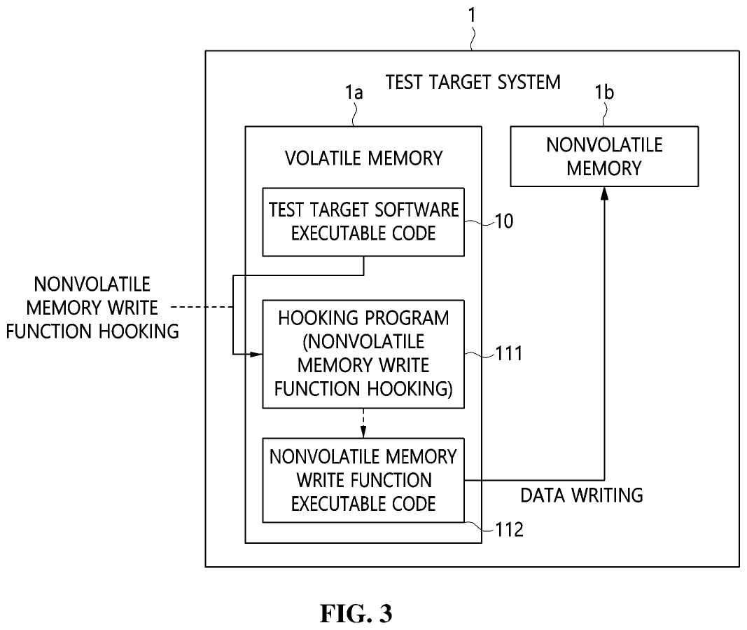

FIG. 3 is a block diagram illustrating in detail a nonvolatile memory write control unit according to an embodiment.

Referring to FIG. 3, the nonvolatile memory write control unit 120 may be implemented using hooking technology.

In the operating system of a computer system, the nonvolatile memory write function “nand_write”, which is a function of writing data to nonvolatile memory (e.g., flash memory) installed in a kernel area, is defined so as to allow a user to write data to nonvolatile memory 1b.

Hooking technology functions to intercept calling of executable code for the nonvolatile memory write function.

That is, the nonvolatile memory write control unit 120 according to an embodiment may allow a hooking program 111 to be executed, instead of the nonvolatile memory write function.

When a request to write data to the nonvolatile memory 1b is received, the hooking program 111 may call nonvolatile memory write function executable code 112, and may write the requested data to the nonvolatile memory 1b or may ignore the request.

Therefore, the nonvolatile memory write control unit 120 may control writing of data to the nonvolatile memory using the hooking program 111.

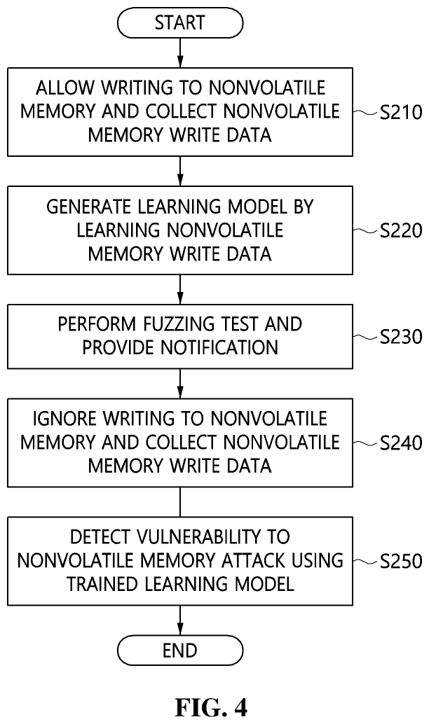

FIG. 4 is a flowchart illustrating a method for detecting a vulnerability to a nonvolatile memory attack according to an embodiment.

Referring to FIG. 4, the method for detecting a vulnerability to a nonvolatile memory attack according to the embodiment may basically include the procedure including steps S210 and S220 of generating a learning model based on nonvolatile memory write data that is collected in a normal state, and the procedure including steps S230 to S250 of generating test data using nonvolatile memory write data that is collected while a fuzzing test is being performed based on the generated learning model.

Here, the procedure including steps S210 and S220 of generating the learning model based on the nonvolatile memory write data that is collected in a normal state may be performed before the fuzzing test is performed.

In detail, at step S210 of allowing writing to the nonvolatile memory and collecting the nonvolatile memory write data, data written to the nonvolatile memory of a test target system may be collected while writing of data to the nonvolatile memory may be allowed.

Further, at step S220 of generating the learning model for determining whether nonvolatile memory data is normal by learning the nonvolatile memory write data, the collected nonvolatile memory write data is learned as normal data, and thus the learning model for determining whether nonvolatile memory data is normal may be generated.

Here, the procedure including steps S230 to S250 of generating the test data using the nonvolatile memory write data that is collected while a fuzzing test is being performed based on the generated learning model may be initiated in response to a notification indicating that the time to detect a vulnerability to a nonvolatile memory attack has arrived because the fuzzing test is being performed.

In detail, at step S240 of collecting nonvolatile memory write data without allowing writing to the nonvolatile memory, the fuzzing test is being performed, and thus data written to the nonvolatile memory of the test target system is collected without allowing writing of data to the nonvolatile memory of the test target system.

Further, at step S250 of detecting a vulnerability to a nonvolatile memory attack using the trained learning model, whether the collected nonvolatile memory write data is normal is determined by applying the learning model for determining whether nonvolatile memory data is normal to the nonvolatile memory write data that is collected while the fuzzing test is being performed, thus detecting a vulnerability to a nonvolatile memory attack.

Through the above-described process, a vulnerability to a nonvolatile memory attack causing failures in booting of the test target system may be detected without interrupting the fuzzing test.

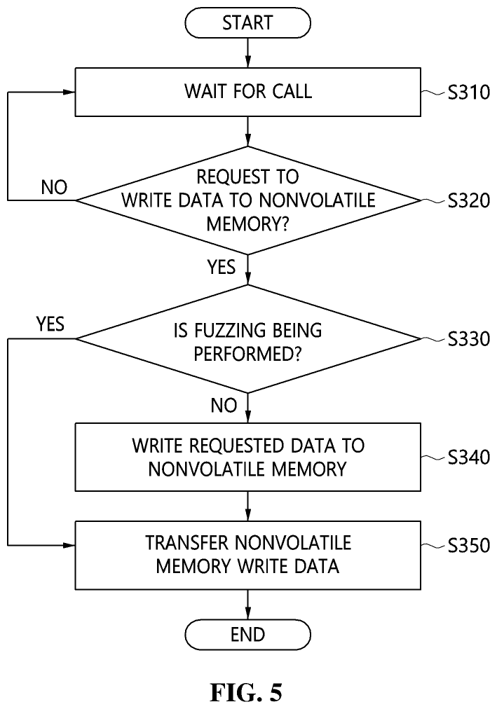

FIG. 5 is a flowchart illustrating the operation of a nonvolatile memory write control unit according to an embodiment.

Referring to FIG. 5, when a request to write data to nonvolatile memory is received from an external program including fuzzing target software (test target software) at step S320 in a call-waiting state at step S310, the nonvolatile memory write control unit 120 determines whether fuzzing is being performed at step S330.

If it is determined at step S330 that fuzzing is not being performed, the nonvolatile memory write control unit 120 may access the nonvolatile memory and allow writing of data to the nonvolatile memory at step S340, and may transfer the data requested to be written to the nonvolatile memory to the attack vulnerability detection unit 130 at step S350.

In contrast, if it is determined at step S330 that fuzzing is being performed, the nonvolatile memory write control unit 120 may directly transfer the data requested to be written to the nonvolatile memory to the attack vulnerability detection unit 130 without allowing access to the nonvolatile memory or writing of data to the nonvolatile memory at step S350.

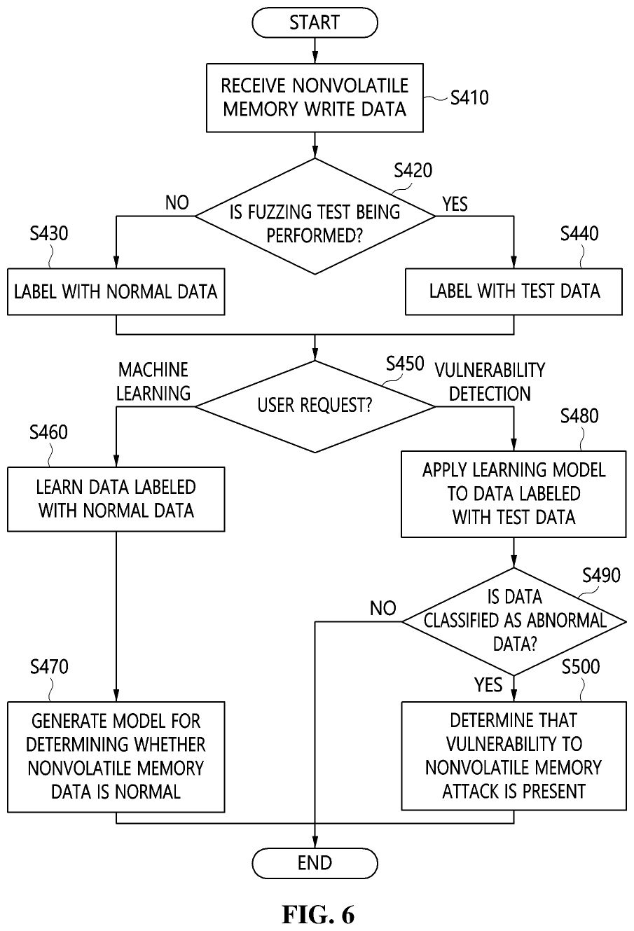

FIG. 6 is a flowchart illustrating the operation of an attack vulnerability detection unit according to an embodiment.

Referring to FIG. 6, when data to be written to nonvolatile memory (i.e., nonvolatile memory write data) is received at step S410, the attack vulnerability detection unit 130 determines whether a fuzzing test is being performed at step S420.

If it is determined at step S420 that a fuzzing test is not being performed, the attack vulnerability detection unit 130 labels the received nonvolatile memory write data with normal data at step S430.

In contrast, if it is determined at step S420 that the fuzzing test is being performed, the attack vulnerability detection unit 130 labels the received nonvolatile memory write data with test data at step S440.

Next, the attack vulnerability detection unit 130 determines whether a request from the user is a request for machine learning or for vulnerability detection at step S450.

If it is determined at step S450 that a request for machine learning is received from the user, the attack vulnerability detection unit 130 learns the data labeled with the normal data at step S460, and generates a learning model for determining whether nonvolatile memory data is normal at step S470.

In contrast, if it is determined at step S450 that a request for vulnerability detection is received from the user, the attack vulnerability detection unit 130 applies the learning model for determining whether nonvolatile memory data is normal to the data labeled with test data at step S480, and checks whether the test data is classified as abnormal data at step S490.

If it is checked at step S490 that the test data is classified as abnormal data, the attack vulnerability detection unit 130 determines that a vulnerability to a nonvolatile memory attack is present at step 5500.

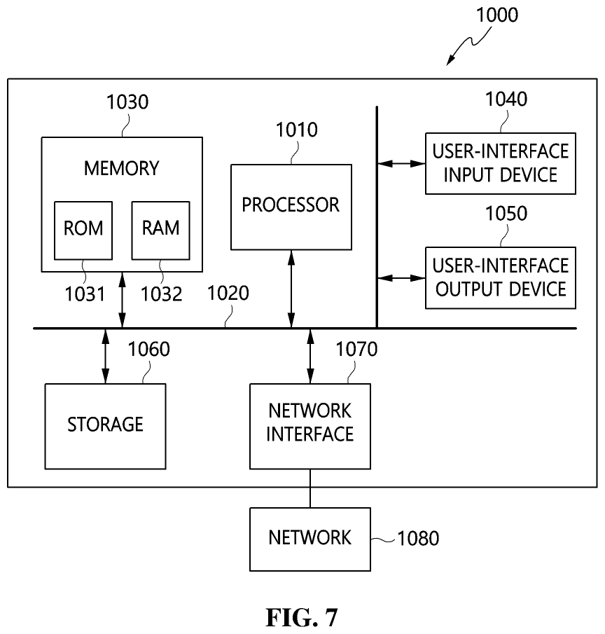

FIG. 7 is a diagram illustrating the configuration of a computer system according to an embodiment.

An apparatus for detecting a vulnerability to a nonvolatile memory attack, or each of a fuzzer unit 110, a nonvolatile memory write control unit 120, and an attack vulnerability detection unit 130 may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium, or an information delivery medium. For example, the memory 1030 may include Read-Only Memory (ROM) 1031 or Random Access Memory (RAM) 1032.

In accordance with an embodiment, there is an advantage in that a vulnerability to a nonvolatile memory attack, which causes failures in system booting by polluting the nonvolatile memory of a test target system, may be detected without interrupting a fuzzing test, thus providing fuzzing automation of automatically performing a fuzzing test.

In accordance with an embodiment, there is an advantage in that whether a vulnerability to a nonvolatile memory attack is present is determined using a model trained with the nonvolatile memory write data, thus providing detection performance higher than that of a determination method only based on a method for detecting whether a failure in system booting is discovered.

Although the embodiments of the present invention have been disclosed with reference to the attached drawing, those skilled in the art will appreciate that the present invention can be implemented in other concrete forms, without changing the technical spirit or essential features of the invention. Therefore, it should be understood that the foregoing embodiments are merely exemplary, rather than restrictive, in all aspects.

What is claimed is:

1. An apparatus for detecting a vulnerability to a nonvolatile memory attack, comprising:
a memory for storing at least one program; and
a processor for executing the program,
wherein the program comprises:
a fuzzer unit for sending a fuzzing message to fuzzing target software;
a nonvolatile memory write control unit for, when a request to write data to a nonvolatile memory is received from the fuzzing target software, transferring nonvolatile memory write data to an attack vulnerability detection unit; and
the attack vulnerability detection unit for, when the nonvolatile memory write data is received from the nonvolatile memory write control unit, searching for a vulnerability to a nonvolatile memory attack based on a result of determining whether the nonvolatile memory write data is normal based on a model pre-trained in a normal state.

2. The apparatus of claim 1, wherein the attack vulnerability detection unit performs:
when the nonvolatile memory write data is received, determining whether a fuzzing test is being performed depending on a notification received from the fuzzer unit as to whether the fuzzing test is to be performed;
when the fuzzing test is being performed, determining whether the nonvolatile memory write data is normal based on the model pre-trained in a normal state; and
when the nonvolatile memory write data is determined to be abnormal, determining that a vulnerability to a nonvolatile memory attack is present.

3. The apparatus of claim 2, wherein:
the attack vulnerability detection unit further performs:
when the fuzzing test is being performed, labeling the nonvolatile memory write data with test data, and
determining whether the nonvolatile memory write data is normal comprises:
determining whether the nonvolatile memory write data is normal based on output of the model that receives the nonvolatile memory write data labeled with the test data.

4. The apparatus of claim 1, wherein:
the attack vulnerability detection unit further performs:
when the fuzzing test is not being performed, labeling the nonvolatile memory write data with normal data, and
the normal data is used as learning data of the model.

5. The apparatus of claim 1, wherein the model is trained such that a result indicating normality is output when the normal data is input.

6. The apparatus of claim 1, wherein:
the nonvolatile memory write control unit performs:
when the request to write data to the nonvolatile memory is received from the fuzzing target software, transferring the nonvolatile memory write data to the attack vulnerability detection unit, and
the nonvolatile memory write control unit further performs:
determining whether a fuzzing test is being performed; and
controlling writing of the nonvolatile memory write data to the nonvolatile memory depending on whether the fuzzing test is being performed.

7. The apparatus of claim 6, wherein the nonvolatile memory write control unit hooks the nonvolatile memory write data using a hooking program.

8. The apparatus of claim 7, wherein the nonvolatile memory write control unit skips writing of data requested to be written to the nonvolatile memory when the fuzzing test is being performed.

9. A method for detecting a vulnerability to a nonvolatile memory attack, comprising:
when nonvolatile memory write data is received, determining whether a fuzzing test is being performed;
when the fuzzing test is being performed, determining whether the nonvolatile memory write data is normal based on a model pre-trained in a normal state; and
when the nonvolatile memory write data is determined to be abnormal, determining that a vulnerability to a nonvolatile memory attack is present.

10. The method according to claim 9, further comprising:
when the fuzzing test is being performed, labeling the nonvolatile memory write data with test data,
wherein determining whether the nonvolatile memory write data is normal comprises:
determining whether the nonvolatile memory write data is normal based on output of the model that receives the nonvolatile memory write data labeled with the test data.

11. The method according to claim 10, further comprising:
when the fuzzing test is not being performed, labeling the nonvolatile memory write data with normal data,
wherein the normal data is used as learning data of the model.

12. The method of claim 9, wherein the model is trained such that a result indicating normality is output when the normal data is input.

13. A method for controlling writing to a nonvolatile memory, comprising:
when a request to write data to a nonvolatile memory is received from fuzzing target software, transferring nonvolatile memory write data to an attack vulnerability detection unit,
wherein the method further comprises:
determining whether a fuzzing test is being performed; and
controlling writing of the nonvolatile memory write data to the nonvolatile memory depending on whether the fuzzing test is being performed.

14. The method of claim 13, wherein transferring the nonvolatile memory write data comprises:
hooking the nonvolatile memory write data using a hooking program.

15. The method of claim 13, wherein controlling the writing comprises:
skipping writing of data requested to be written to the nonvolatile memory when the fuzzing test is being performed.
